(19) United States
(12) Patent Application Publication
(10) Pub. No.: US 2003/0014939 A1
(43) Pub. Date: Jan. 23, 2003

(54) Junction box and fixture installation method

(76) Inventor: Harold O. DeWall, Escondido, CA (US)

Correspondence Address: Mr. Loyal M. Hanson, Hanson Law Corporation, P.O. Box 430, Fallbrook, CA, 92088-0430, US

(21) Appl. No.: 09/910,536

(22) Filed: Jul. 20, 2001

(51) Int. Cl. E04H 14/00; H01H 9/02; H01R 13/46; E04G 21/00

(52) U.S. Cl. 52/741.1; 52/742.1; 52/27; 174/53; 174/57; 174/58

(57) ABSTRACT

A method for installing a junction box on a building framework in conjunction with the installation of wallboard includes providing a junction box having a junction box component, an extension component, and elements for connecting the extension component to the junction box component. The method proceeds by (i) mounting the junction box component on the building framework, (ii) mounting a sheet of wallboard on the building framework over the junction box component, (iii) cutting a hole in the sheet of wallboard in order to expose the junction box component, and (iv) inserting the extension component through the hole in the sheet of wallboard in order to thereby connect the extension component to the junction box component. Doing so significantly facilitates wallboard installation while enabling off-site mounting of a fixture on the extension component. A junction box constructed according to the invention includes a junction box component, an extension component, and connecting elements that enable a person to proceed as described above, with the forward end portion of the junction box component mounted even with the outwardly facing surface of the building framework.

### BACKGROUND OF THE INVENTION

1. Technical Field

This invention relates generally to building construction equipment and techniques. It relates more particularly to electrical outlet boxes, other junction boxes, fixtures that mount on the junction boxes, and to a method for installing fixtures on junction boxes that are mounted on a building framework behind drywall or other wallboard.

2. Description of Related Art

The term “fixture” herein refers to electrical outlets, lighting fixtures, heating and air conditioning components, speaker outlets, home security outlets, ceiling fans, plumbing components, and the like, that mount on a junction box. The term “junction box” refers to any of various types of components mounted on the wall studs or other framework of the building as part of the installation of fixtures on the outwardly facing side of the wallboard that faces away from the framework. The term “wallboard” herein refers to gypsum wallboard (“drywall”), plywood, and any of various other types of sheet material used to cover the wall studs or other framework of a building. The junction boxes are usually installed first. Another crew adds the wallboard over them. Then, an electrician or other licensed person installs the fixtures.

Consider, for example, the task of installing fixtures in the form of electrical outlets on junction boxes in the form of electrical outlet boxes. The outlet boxes have already been nailed, screwed, or otherwise attached on the wall studs of a new building under construction, and an electrician has already strung wiring to them. Each outlet box provides a physical support on which to mount an electrical outlet. It also serves as a terminal structure to which to string wiring to be electrically connected to the electrical outlet, and as a protective enclosure for the electrical connection.

The drywall installers (i.e., drywallers) nail or screw sheets of drywall to the studs right over the electrical outlet boxes. The outlet boxes usually extend outwardly from the studs the thickness of the drywall (e.g., ⅝″) and so the drywall is initially bowed somewhat and nailed or screwed to the studs loosely in order to accommodate the protruding outlet boxes. Next, the drywallers locate the outlet boxes and cut holes or openings in the drywall at each outlet box location so that the outlet boxes protrude into the holes and the drywall lies flat against the studs. Then, they add more nails or screws and proceed to tape the drywall and so forth to finish the installation.

The task of locating the electrical outlet boxes and cutting the holes is usually accomplished by measuring the location of each outlet box relative to the floor or ceiling, and then using those measurements to determine the right hole locations in the drywall (i.e., cutout locations). The drywallers use a router tool to form a hole (i.e., a cutout) at each cutout location so that the electrical outlet box protrudes into the cutout and the drywall lies flat against the studs. Then, they complete the nailing or screwing of the drywall to the studs. This time-consuming procedure also applies for cutouts for other types of junction boxes. It is especially costly using high-skilled drywallers. The cost increases as licensed electricians return to the site to install the electrical outlets and other fixtures, using significant time to wire each outlet or other fixture, mount each on the associated junction box, and then add a cover plate or other required components. Thus, there is a need for a better way to install fixtures and junction boxes, and a need for a better junction box designed to alleviate some of the high installation costs.

### SUMMARY OF THE INVENTION

This invention addresses the concerns outlined above providing a method of installing a junction that proceeds using a two-piece junction box. The first piece, a junction box component, is mounted on a building framework so that it is even with the building framework. The second piece, and extension component, is added after the wallboard has been installed. It is inserted through a hole in the wallboard and snapped into engagement of the junction box component.

Thus, the drywallers need not concern themselves with the time-consuming requirements associated with existing junction boxes that extend outwardly beyond the building framework. They simply put up and tape the wallboard. Thereafter, holes are cut and extension components are added as need. In addition, fixtures can be mounted on the extension components off-site, and that translates to even more efficiency and related cost savings.

To paraphrase some of the more precise language appearing in the claims, a method for installing a junction box on a building framework in conjunction with the installation of wallboard includes providing a junction box having a junction box component, an extension component, and elements for connecting the extension component to the junction box component. The method proceeds by (i) mounting the junction box component on the building framework, (ii) mounting a sheet of wallboard on the building framework over the junction box component, (iii) cutting a hole in the sheet of wallboard in order to expose the junction box component, and (iv) inserting the extension component through the hole in the sheet of wallboard in order to thereby connect the extension component to the junction box component.

A junction box constructed according to the invention includes a junction box component, an extension component, and connecting elements that enable a person to proceed as described above, with a forward end portion of the junction box component mounted even with the outwardly facing surface of the building framework. Doing so significantly facilitates wallboard installation while enabling off-site fixture mounting on the extension component. The following illustrative drawings and detailed description make the foregoing and other objects, features, and advantages of the invention more apparent.

### BRIEF DESCRIPTION OF THE DRAWINGS

FIG. 1 of the drawings is an isometric view of the junction box component a junction box in the form of an electrical outlet box constructed according to the invention, shown mounted on a stud so that it is even with the stud;

FIG. 2 is an isometric view of a sheet of drywall mounted on the stud over the junction box component;

FIG. 3 is an isometric view of the extension component with a fixture in the form of an electrical outlet pre-mounted on it, shown after an electrician has wired the electrical outlet through the hole cut in the sheet of drywall in preparation for inserting the extension component into the hole;

FIG. 4 is an isometric view showing insertion of the extension component through the hole in the sheet of drywall and into engagement of the first component;

FIG. 5 is a side elevation view showing the junction box component and the extension component box fully assembled to form an electrical outlet box;

FIG. 6 is an enlarged cross section of a portion of the assembled electrical outlet box as viewed in a horizontal plane containing line 6-6 in FIG. 5, showing the connecting elements;

FIG. 7 is a side elevation of a second embodiment of an electrical outlet box constructed according to the invention that has different connecting elements;

FIG. 8 is an enlarged cross section of a portion of the second embodiment as viewed in a horizontal plane containing line 8-8 in FIG. 7;

FIG. 9 is a disassembled view of the junction box component and the extension component of a third embodiment of an electrical outlet box constructed according to the invention; and

FIG. 10 is an enlarged side elevation view showing the connecting elements of the third embodiment.

### DESCRIPTION OF THE PREFERRED EMBODIMENTS

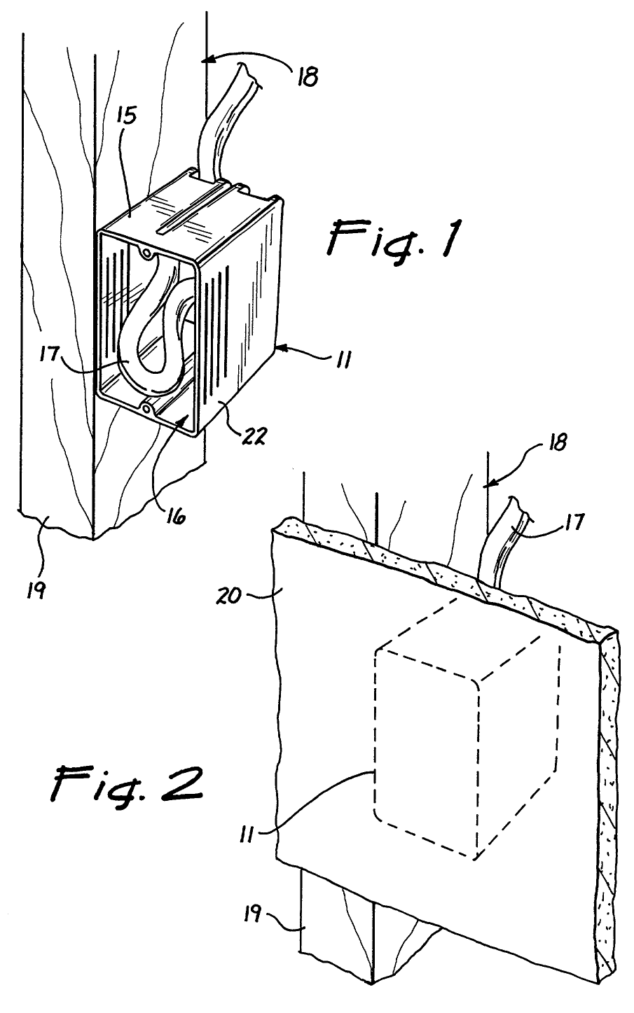

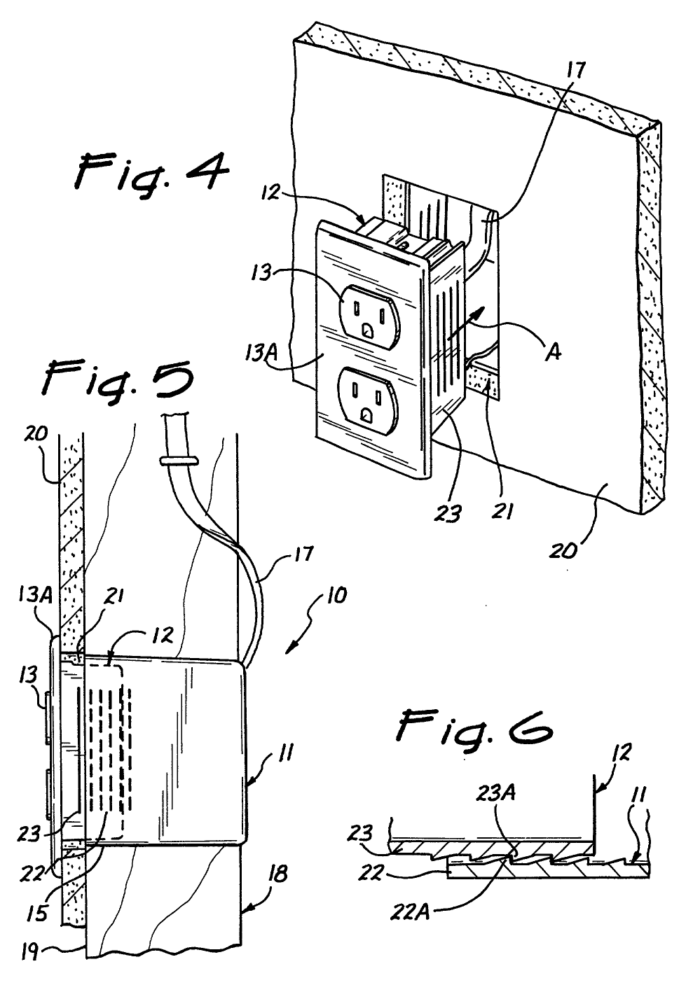

FIGS. 1-6 of the drawings show various aspects of a junction box constructed according to the invention in the form of an electrical outlet box 10. The assembled electrical outlet box 10 is shown in FIG. 5. It includes a junction box component 11 (FIGS. 1-5) and an extension component 12 (FIGS. 3-5). Those components cooperate as an electrical outlet box for a fixture in the form of a conventional electrical outlet 13 and its cover plate 13A (FIGS. 3-5).

The junction box component 11 is similar in some respects to existing electrical outlet boxes in that it has an interior 14 (FIG. 3) and a forward end portion 15 that defines an opening 16 (FIGS. 1 and 3) providing access to the interior 14 and wiring 17 within the interior 14. It may be fabricated of plastic, metal, or other suitably rigid material. As a further idea of size, the illustrated junction box component 11 measures about 3.75 inches high, 2.25 inches wide, and 3.25 inches deep. Of course, those dimensions may vary greatly without departing from the inventive concepts described.

The junction box component 11 is shown in FIG. 1 mounted on a building framework 18 (e.g., a two-by-four stud) in a position such that the forward end portion 15 of the junction box component 11 is even with a surface 19 of the building framework 18 (FIGS. 1, 2, and 5) on which a sheet of wallboard 20 is to be installed. That position facilitates wallboard installation significantly because drywallers do not have to carefully bow the wallboard over protruding junction boxes before nailing the wallboard loosely in place, cut holes at each junction box location, and then nail or screw the wallboard more securely. Instead, they securely install all the wallboard right from the start and then tape it in a quicker and more efficient operation.

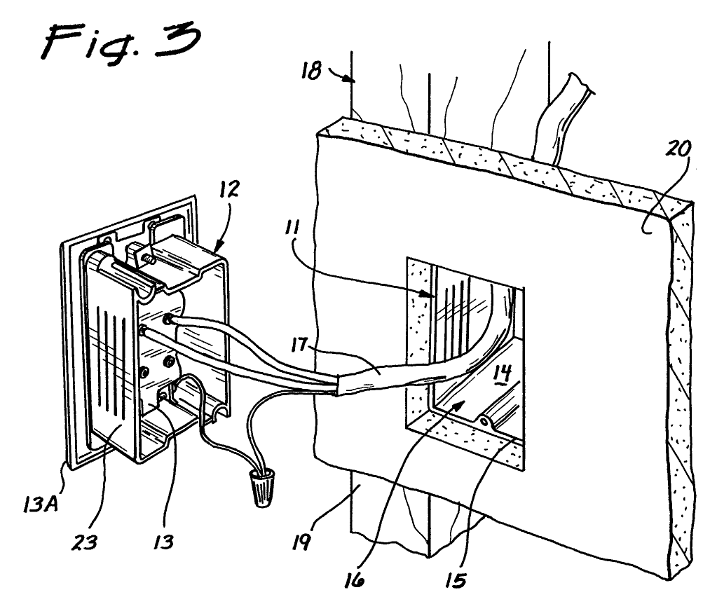

The junction box component 11 is adapted to be so mounted on the building framework 18 in that it has a suitable size and shape and a suitable mounting arrangement to be mounted on the building framework (e.g., the inclusion of holes through which to nail or screw it to the building framework 18). Once mounted, the opening 16 faces outwardly toward the sheet of wallboard 20 after the sheet of wallboard 20 is installed in the position shown in FIG. 2, and there it provides a physical support for the assembled combination of the extension component 12 and the electrical outlet 13 with its cover plate 13A. It also serves as a terminal structure to which to string the wiring 17 to be electrically connected to the electrical outlet 13, and as a protective enclosure for the electrical connections.

The extension component 12 is adapted to function as means for extending the forward end portion 15 of the junction box component 11. It is so adapted in the sense that it has a shape that mates with the shape of the forward end portion 15 so that it can be connected to the junction box component 11 as an extension of the forward end portion 15. Preferably, it is composed of the same type of material as the junction box component 11. Once connected to the junction box component 11, the extension component 12 extends from the forward end portion 15 of the junction box component 11, into a hole 21 (FIGS. 4 and 5) that a worker has cut into the sheet of wallboard 20 (in alignment with the opening 16 in the junction box component 11) after the sheet of wallboard 20 has been installed on the building framework 18 over the junction box 15. In the case of a ⅝-inch thick sheet of wallboard, such as the sheet of wallboard 18, the extension component 12 extends beyond the forward end portion 15 of the junction box component 11 (and therefore beyond the surface 19 of the building framework 18) about ⅝ inch.

In addition to the junction box component 11 and the extension component 12, the electrical outlet box 10 includes means for connecting the extension component 12 to the junction box component 11. Any of various connecting arrangements can be used to accomplish this function so long as the means employed enables a person to do so through the hole 21 in the sheet of wallboard 20. In other words, it must enable the person to connect the extension component 12 to the junction box component 11 by inserting the extension component 12 through the hole 21 in the sheet of wallboard 20 (as depicted by an arrow A in FIG. 4) and into contact with the junction box component 11 after the sheet of wallboard 20 is installed on the framework 18 over the junction box component 11. In the case of a pre-mounted fixture on the extension component 12, such as the electrical outlet 13, an electrician connects the wiring 17 to the fixture before inserting the extension component 12 through the hole 21. Based upon the foregoing description, one of ordinary skill in the art can readily implement suitable junction box and extension components along with suitable connecting means to practice the invention.

For connecting purposes, the illustrated junction box component 11 includes at least one (preferably more than one) first barb-defining portion 22 (FIGS. 1, 5, and 6) and the extension component 12 includes at least one (preferably more than one) second barb-defining portion 23 (FIGS. 3-6) that is adapted to engage the first barb-defining portion 22 when the extension component is slid into the junction box component. FIG. 6 shows an outwardly protruding barb 23A of the second barb-defining portion 23 engaging an inwardly protruding barb 22A of the first barb-defining portion 22. That locks the two components together. It may be said that the components 11 and 12 snap together as the barb-defining portions 22 and 23 resiliently deform slightly and then recover to lock the two components together. Thereafter, a repairman or other person gains access to the interior 14 of the junction box component 11 by removing the cover plate 13A and the electrical outlet 13 in the usual way.

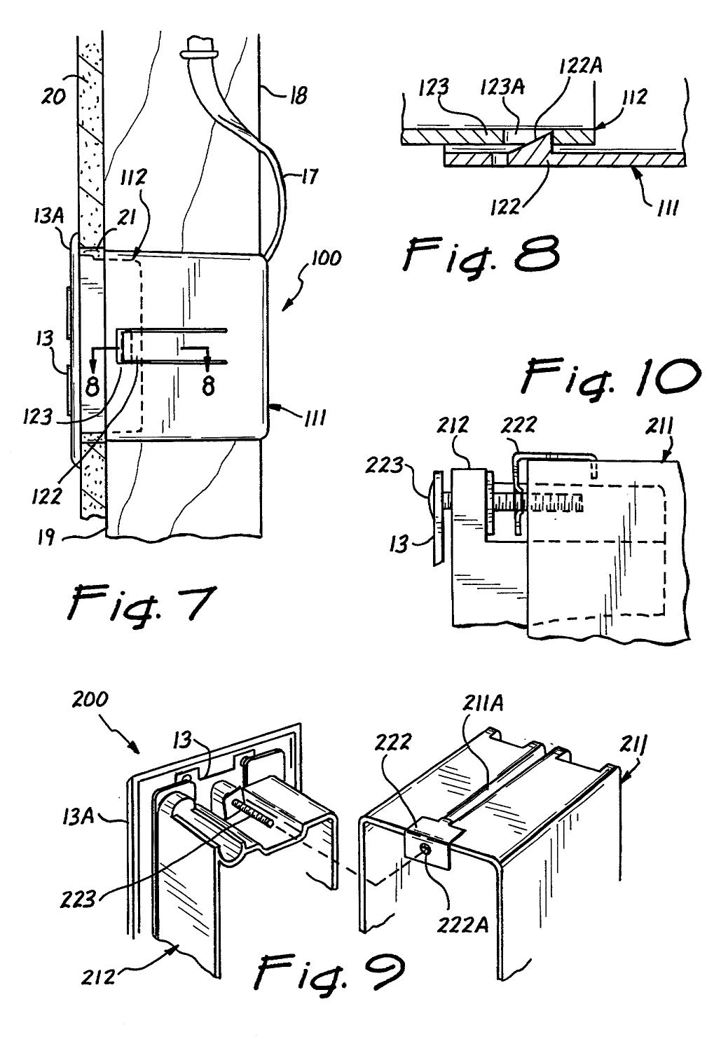

FIGS. 7 and 8 illustrate a second embodiment of the invention in the form of an electrical outlet box 100 that includes a different connecting arrangement. The electrical outlet box 100 is similar in some respects to the electrical outlet box 10 and so only differences are described in further detail. For convenience, reference numerals designating parts of the electrical outlet box 100 are increased by one hundred over those designating counterparts or similar parts of the electrical outlet box 10.

Similar to the electrical outlet box 10, the electrical outlet box 100 includes a junction box component 111, an extension component 112, and means for connecting the extension component 112 to the junction box component 111 through the hole 21 in the sheet of wallboard 20. The connecting means are a little different, however. The junction box component 111 includes at least one (preferably more than one) hook-defining portion 122, and the extension component 112 includes at least one (preferably more than one) recess-defining portion 123 that is adapted to engage the hook-defining portion 122 for purposes of connecting the extension component 112 to the junction box component 111. FIG. 8 shows an outwardly protruding hook 122A formed by hook-defining portion 122 that is seated in a recess 123A formed by the recess-defining portion 123. That locks the two components together. They snap together as the hook 122A resiliently deforms slightly and then recovers to seat in the recess 123A.

FIGS. 9 and 10 illustrate a third embodiment of the invention in the form of an electrical outlet box 200 that includes another different connecting arrangement. The electrical outlet box 200 is similar in some respects to the electrical outlet box 10 and so only differences are described in further detail. For convenience, reference numerals designating parts of the electrical outlet box 200 are increased by two hundred over those designating counterparts or similar parts of the electrical outlet box 10.

Similar to the electrical outlet box 10, the electrical outlet box 200 includes a junction box component 211, an extension component 212, and means for connecting the extension component 212 to the junction box component 211 through the hole 21 in the sheet of wallboard 20. The junction box component 211 takes the form of an existing junction box manufactured without connecting elements, and the electrical outlet box 200 includes at least one (preferably more than one) screw-engaging clip component 222 (e.g., thin spring steel) that is clipped onto the junction box component 212 as part of the connecting means as illustrated in FIGS. 9 and 10. The clip component 222 has a size and shape that mates with contours of the junction box component 211 (e.g., engaging a groove 211A on the junction box component 211 that is identified in FIG. 9). The electrical outlet box 200 also includes a screw 223 extending through the extension component 212 that cooperates with the clip component 222 as connecting means. The person installing the extension component 212 forces the screw 223 into a tight-fitting hole 222A in the clip component 222. Doing so results in the screw 223 engaging the clip component 222 for purposes of connecting the extension component 212 to the junction box component 211.

Recapitulating the methodology employed, a method for installing a junction box on a building framework in conjunction with the installation of wallboard on the building framework includes the step of providing a junction box that includes (i) a junction box component, (ii) an extension component, and (iii) means for connecting the extension component to the junction box component. The method proceeds by mounting the junction box component on the building framework, mounting a sheet of wallboard on the building framework over the junction box component, cutting a hole in the sheet of wallboard in order to expose the junction box component, and inserting the extension through the hole in the sheet of wallboard in order to thereby connect the extension component to the junction box component.

Thus, the method and junction boxes of the invention greatly facilitates wallboard installation by enabling mounting of the junction box component even with the building framework. It also enables off-site mounting of a fixture on the extension component for further increased efficiency and cost savings. Although exemplary embodiments have been shown and described, one of ordinary skill in the art may make many changes, modifications, and substitutions without necessarily departing from the spirit and scope of the invention. For example, the extension component can be connected to the junction box component by glue or other suitable bonding means. That alternative is intended to fall within the scope of the claims. The means for connecting the extension component to the junction box component is hereby defined to include gluing or otherwise bonding the two components together.

What is claimed is:

1. A method for installing a junction box on a building framework in conjunction with the installation of wallboard on the building framework, the method comprising:
providing a junction box that includes (i) a junction box component, (ii) an extension component, and (iii) means for connecting the extension component to the junction box component;
mounting the junction box component on the building framework;
mounting a sheet of wallboard on the building framework over the junction box component;
cutting a hole in the sheet of wallboard in order to expose the junction box component; and
inserting the extension through the hole in the sheet of wallboard in order to thereby connect the extension component to the junction box component;
thereby facilitating the installation of wallboard on the building framework.

2. A method as recited in claim 1, wherein the step of mounting the junction box component on the building framework includes mounting the junction box component on the building framework so that a forward end portion of the junction box component does not extend beyond an outwardly facing surface of the building framework on which the sheet of wallboard will be mounted.

3. A method for installing a fixture and a junction box on a building framework in conjunction with the installation of wallboard on the building framework, the method, comprising:
providing a junction box that includes (i) a junction box component, (ii) an extension component, and (iii) means for connecting the extension component to the junction box component;
mounting the fixture on the extension component;
mounting the junction box component on the building framework;
mounting a sheet of wallboard on the building framework over the junction box component;
cutting a hole in the sheet of wallboard in order to expose the junction box component; and
inserting the extension through the hole in the sheet of wallboard in order to thereby connect the extension component to the junction box component;
thereby enabling off-site mounting of the fixture on the extension component.

4. A method as recited in claim 3, wherein the step of mounting the junction box component on the building framework includes mounting the junction box component on the building framework so that a forward end portion of the junction box component does not extend beyond an outwardly facing surface of the building framework on which the sheet of wallboard will be mounted.

5. A junction box, comprising:
a junction box component having an interior and a forward end portion that defines an opening providing access to the interior;
an extension component adapted to function as means for extending the forward end portion of the junction box component; and
means for connecting the extension component to the junction box component;
wherein the means for connecting the extension component to the junction box component is adapted to enable a person to connect the extension component to the junction box component by inserting the extension component through a hole in the sheet of wallboard and into contact with the junction box component after the sheet of wallboard is installed on the framework over the junction box component.

6. A junction box as recited in claim 5, wherein:
the junction box component is an existing junction box manufactured without a connecting element;
the junction box includes at least one first connecting element that has been added to the junction box component; and
the extension component includes at least one second connecting element that is adapted to engage the first connecting element for purposes of connecting the extension component to the junction box component.

7. A junction box as recited in claim 6, wherein the first connecting element includes a screw-engaging member adapted to clip onto the existing junction box and the second connecting element includes a screw adapted to engage said screw-engaging member for purposes of connecting the extension component to the junction box component.

8. A junction box as recited in claim 5, wherein the means for connecting the extension component to the junction box component includes at least one first barb-defining portion of the junction box component and at lease one second barb-defining portion of the extension component that is adapted to engage said first barb-defining portion for purposes of connecting the extension component to the junction box component.

9. A junction box as recited in claim 5, wherein the means for connecting the extension component to the junction box component includes at least one hook-defining portion of the junction box component and at least one recess-defining portion of the extension member that is adapted to engage said hook-defining portion for purposes of connecting the extension component to the junction box component.
